(19) United States
(12) Patent Application Publication
(10) Pub. No.: US 2017/0021561 A1
(43) Pub. Date: Jan. 26, 2017

(54) Method, line and machine for manufacturing a flexible hose/connector assembly of polymeric material

(71) Applicant: FITT S.P.A., Sandrigo (VI) (IT)

(72) Inventors: Alessandro Mezzalira, Sandrigo (VI) (IT); Valentino Vigolo, Sandrigo (VI) (IT); Andrea Petronilli, Sandrigo (VI) (IT); Alessandro Cegalin, Sandrigo (VI) (IT)

(73) Assignee: FITT S.P.A., Sandrigo (VI) (IT)

(21) Appl. No.: 15/302,166

(22) PCT Filed: Apr. 13, 2015
(86) PCT No.: PCT/IB2015/052674

§ 371 Date: Oct. 6, 2016

(30) Foreign Application Priority Data
Apr. 11, 2014 (IT) VI2014A000106

(51) Int. Cl. B29C 65/00; F16L 13/02; F16L 33/34; B29C 65/06

(52) U.S. Cl. CPC B29C 66/5344; B29C 65/0672; B29C 66/73152; F16L 13/02; F16L 33/34; B29L 2023/005

(57) ABSTRACT

A method for manufacturing a hose/connector assembly of polymeric material includes the steps of: providing a flexible hose of a first thermoplastic material; providing the connector of a second thermoplastic material having a hardness greater than the first thermoplastic material and a first end for coupling with a liquid source and a second end with a seat for receiving one end of the hose; translating the end of the flexible hose to engage the seat of the connector; rotating the connector to cause a rotational friction welding with the flexible hose; and periodically comparing the welding torque with the maximum allowable torque for the hose and the connector. The step of rotating the connector with respect to the hose is interrupted if the welding torque is equal to or greater than the maximum allowable torque.

### FIELD OF THE INVENTION

The present invention is generally applicable to the technical field of polymer articles manufacturing and particularly relates to method, line and machine for manufacturing a hose/connector assembly of polymer material.

### BACKGROUND OF THE INVENTION

Hose/connector assemblies of plastic material are known that essentially includes a flexible hose of thermoplastic material, usually plasticised PVC, and a connector of plastic material, generally rigid PVC, welded together by friction welding.

Such assemblies are known, for example, from European patent EP2047169, in the name of the same Applicant.

The manufacturing of such assemblies involves a number of problems, essentially due to the dimensional variability of the thermoplastic hose leaving the extruder.

In fact, the thermoplastic material is extruded at high temperatures and once in contact with the ambient air retracts, thus varying the actual dimensions compared to the nominal one. It is apparent that this phenomenon is not constant, but varies depending on the parameters of the ambient air, such as temperature, humidity or the like, and more generally on the process parameters, such as line speed, the extrusion temperature or the like.

This affects negatively the mechanical/hydraulic seal of the joint between hose and connector, and thus increase the production waste. In turn, this affects negatively the productivity of the process and, more generally, the times and costs of manufacturing.

Another problem is the increased hardness of the polymeric material of the connector compared to that of the hose. In fact, upon rotation of the connector to weld it to the hose the former tends to put in rotation the latter, with the consequent collapse of the joint.

From the U.S. Pat. No. 6,199,916 an assembly for automotive is known between a technical hose of relatively high thickness made of polyamide and a fitting made of polyamide loaded with glass fiber. This document suggests that to minimize the overall dimensions of the assembly the welding between hose and connector must take place only in part and not along the entire weld interface.

The German patent DE10354526 discloses a machine for rotational friction welding, also used in the automotive industry, adapted to frictionally weld metallic or plastic parts. The arms of the machine can be successfully fitted with force sensors and/or torque so that the friction welding always takes place on the basis of predetermined parameters.

### SUMMARY OF THE INVENTION

Object of the present invention is to overcome at least partially the above mentioned drawbacks, by providing a method which allows to minimize the time and costs of manufacturing of a hose/connector assembly of polymeric material.

Another object of the invention is to provide a method for manufacturing a hose/connector assembly of polymeric material which has characteristics of high productivity.

Another object of the invention is to provide a method for manufacturing a hose/connector assembly of polymeric material that allows minimizing production waste.

These objects, and others which will appear more clearly hereinafter, are achieved by a method for manufacturing a hose/connector assembly of polymeric material comprising a flexible hose which includes at least one layer made of a first thermoplastic material, preferably plasticized PVC, and a connector made of a second thermoplastic material, preferably rigid PVC. In any case, the second thermoplastic material of the connector may have a hardness greater than the first thermoplastic material.

In a per se known manner, the connector may have a first end, which may for example be threaded, to be connected to a fluid source, such as a tap or the like, and a second end with a seat suitable for coaxially receiving a end of the hose.

For example, such seat may be defined by an end central projection and peripheral ring of the connector, mutually faced to each other.

The method for manufacturing the hose/connector assembly made of polymeric material may comprise the steps of providing the flexible hose; providing the connector; mutual approaching of hose and connector so that the end of the former is inserted into the seat of the latter; rotating the connector with respect to the flexible hose so as to mutually rotationally friction weld them.

To avoid the collapsing of the mechanical joint between the hose and the connector, the method may further comprises a step of periodic comparing the welding torque that develops between hose and connector with the maximum allowable torque for the same, that is the limit torque from which the connector rotates the flexible hose upon the rotation of the former relatively to the latter.

Conveniently, the rotating step of the connector with respect to the flexible hose stops if the welding torque is equal to or exceeds the maximum allowable torque.

To do this, the rotating step can be carried out by means of a machine for the rotational friction welding of a hose and a connector which includes a first section which can house the connector and a second section susceptible to receive the end of the hose.

Advantageously, the first section may rotate the connector so as to mutually rotationally friction weld the hose and the connector.

Conveniently, the machine may further comprise a microprocessor unit PLC for the periodic comparison of the welding torque with the maximum allowable torque.

The value of the latter may be preset or settable into the PLC, for example by means of a keyboard.

In a preferred but not exclusive embodiment, the value of the maximum allowable torque between the connector and the hose can be predetermined by means of a torque meter.

In this case, the output value from the torque meter can be manually set in the unit or automatically set in the same unit if torque meter and PLC unit are operatively connected.

Advantageous embodiments of the invention are defined in accordance with the dependent claims.

### BRIEF DESCRIPTION OF THE DRAWINGS

Further features and advantages of the invention will appear more evident reading the detailed description of some preferred not-exclusive embodiments of a line 100 for manufacturing a hose/connector assembly 1 of polymeric material, which is shown as a non-limiting example with the help of the annexed drawings, wherein:

FIGS. 1a and 1b are schematic partially sectioned views of a hose/connector assembly 1 before the mutual coupling, in which the connector 20 shown in FIG. 1a is of the female type and the one shown in FIG. 1b is of the male type;

FIGS. 2 to 5 are schematic views of the line 100 during various steps of the method of manufacturing the hose/connector assembly 1;

FIG. 5a is an enlarged view of certain details of FIG. 5;

FIG. 6 is an enlarged partially sectioned view of the hose/connector assembly 1 of FIG. 1a or 1b as a result of the mutual coupling.

### DETAILED DESCRIPTION OF A PREFERRED EMBODIMENT

With reference to the above figures, the method is aimed to obtain an hose/connector assembly 1 made of polymeric material, for example of the type shown in the European patent EP2047169, in the name of the same Applicant.

The assembly 1, which may be made entirely of polymer material, may include or may consist of a flexible hose 10 and a connector 20, welded together by friction rotating.

The flexible hose 10, which may define an axis X, may include or may consist of at least one layer 11 of a thermoplastic material, for example plasticized PVC (P-PVC).

Indicatively, the Shore A hardness according to ISO 868 of the thermoplastic material of the at least one layer 11 may be of 50 Sh A to 90 Sh A.

Also, the elastic modulus according to ISO 527 of the thermoplastic material of the at least one layer 11 may be of 700 MPa to 1500 MPa.

In addition, the yield stress according to ISO 527 of the thermoplastic material of the at least one layer 11 may be of 15 MPa to 25 MPa.

Further, the tension at break according to ISO 527 of the thermoplastic material of the at least one layer 11 may be of 15 MPa to 25 MPa.

In addition, the elongation at break according to ISO 527 of the thermoplastic material of the at least one layer 11 may be of 300% to 450%.

Conveniently, the flexible hose 10 may include any number of layers in any polymeric material, and may or may not be reinforced by means of one or more textile reinforcement layers of the knitted, braided, woven or similar type. The wires of these reinforcement layers may be made of polyester.

In a preferred but not exclusive embodiment, the flexible hose 10 may be an irrigation hose or garden hose and may include or may consist of at least one inner layer 11 in contact with the liquid to be transported, generally water, a textile reinforcement Intermediate braided or knitted layer 12 and at least one outer protective layer 13 susceptible to be grasped by a user.

In this case, in a garden hose with inner diameter of ½″ (half-inch, 12.7 mm) the at least one inner layer 11 may have a thickness of 1.3 mm to 1.45 mm, while the at least one outer protective layer 13 may have a thickness of 0.75 mm to 0.85 mm.

On the other hand, in a garden hose with inner diameter of ⅝″ (⅝ inch, 15.88 mm) the at least one inner layer 11 may have a thickness of 1.4 mm to 1.9 mm, while the at least one outer protective layer 13 may have a thickness of 0.80 mm to 1 mm.

On the other hand, in a garden hose with inner diameter of ¾″ (¾ inch, 19.05 mm) the at least one inner layer 11 may have a thickness of 1.6 mm to 1.9 mm, while the at least one outer protective layer 13 may have a thickness of 1 mm to 1.1 mm.

The connector 20 can be made of another thermoplastic material having a hardness greater than the first thermoplastic material, for example rigid PVC (u-PVC) or ABS.

Indicatively, the Shore hardness according to ISO 868 of the thermoplastic material of the connector 20 may be of 70 Sh Sh D to 100 Sh D.

In addition, the HDT at 1.82 MPa according to ISO 75-2 of the thermoplastic material of the connector 20 may be of 60° C. and 90° C.

Also, the elastic modulus according to ISO 527 of the thermoplastic material of the connector 20 may be of 2500 MPa to 4000 MPa.

In addition, the yield stress according to ISO 527 of the thermoplastic material of the connector 20 may be of 30 MPa to 100 MPa.

In addition, the tension at break according to ISO 527 of the thermoplastic material of the connector 20 may be of 30 MPa to 100 MPa.

In addition, the elongation at break according to ISO 527 of the thermoplastic material of the connector 20 will be between 100% to 250%.

In addition, the Izod impact strength at 23° C. according to ISO 180/4A of the thermoplastic material of the connector 20 may be of 10 KJ/m2 to 50 KJ/m2.

More generally, the polymeric material of the flexible hose 10 may be compatible with the thermoplastic material of the connector 20.

In the present text, the wording “compatible materials” is to be understood as materials having chemical and/or physical compatibility, that is materials which, once coupled, give rise to a junction able to support the transfer of traction or shear stresses through the contact surface. It follows that the maximum compatibility is achieved between identical materials or anyway for materials of the same nature.

The polymeric material of the connector 20 has a greater hardness than the thermoplastic material of the flexible hose 10.

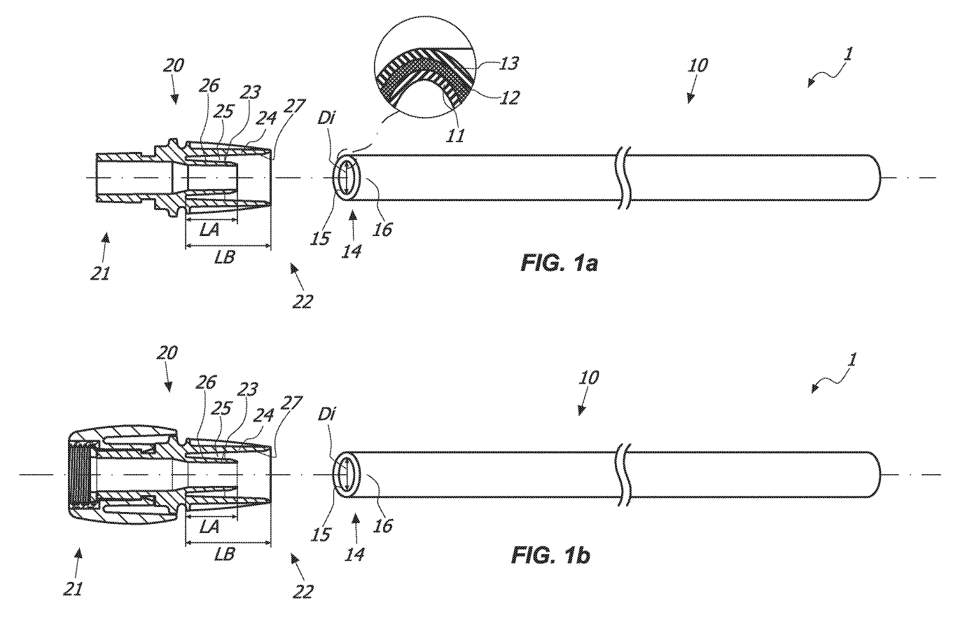

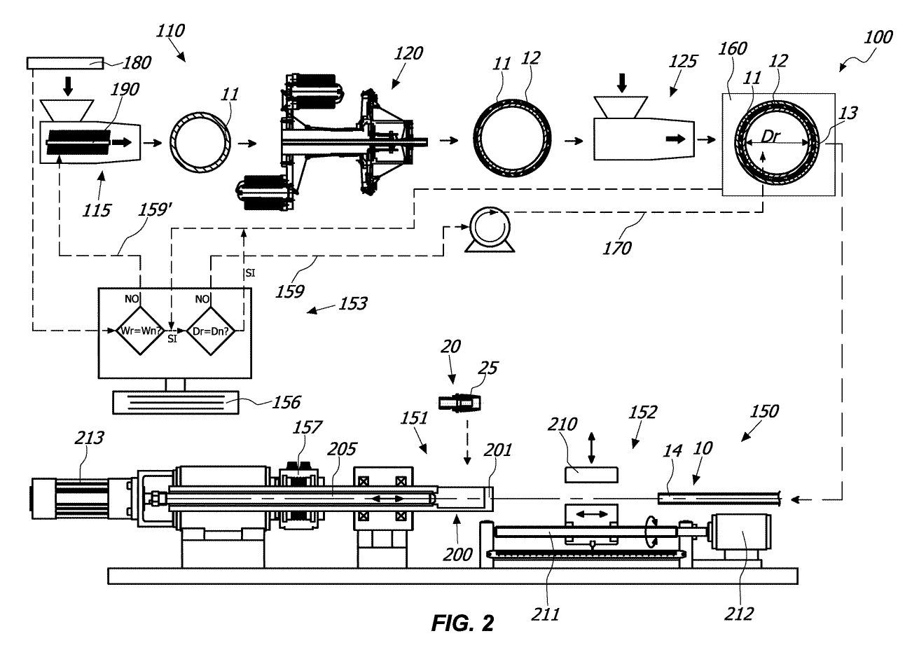

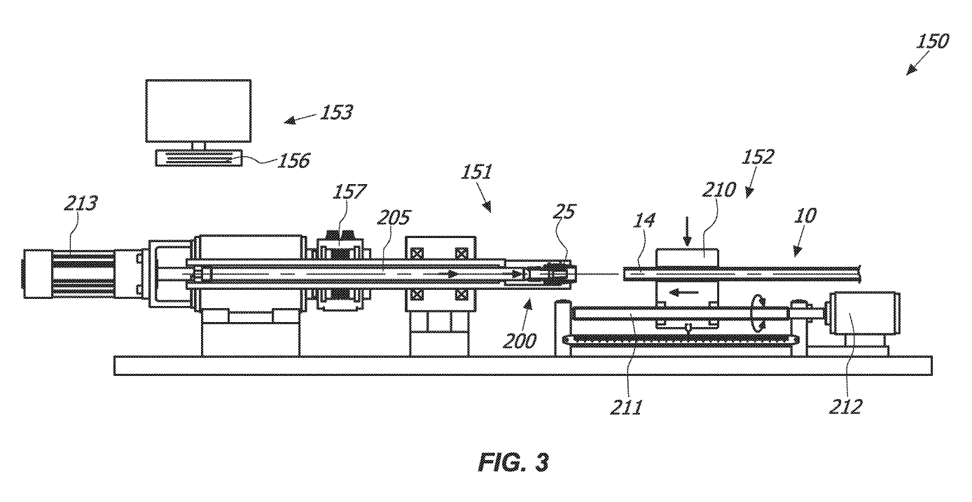

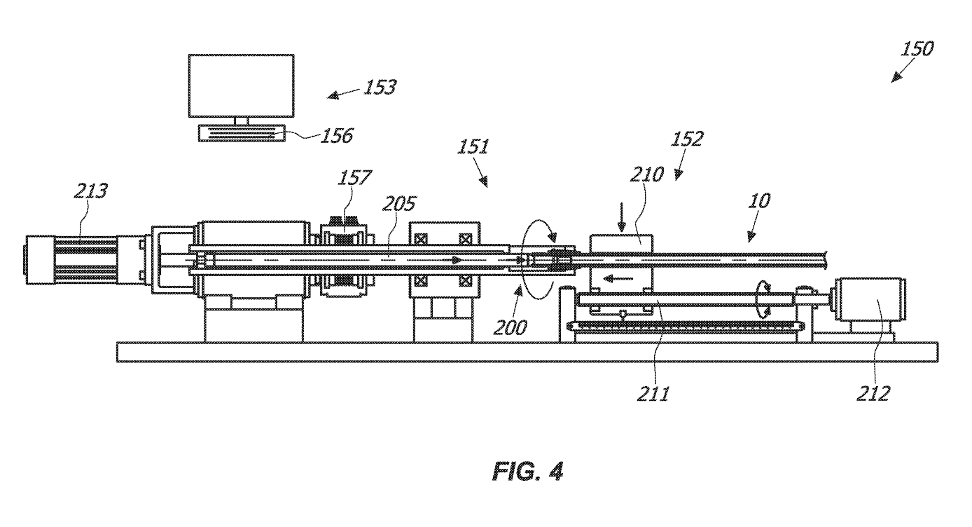

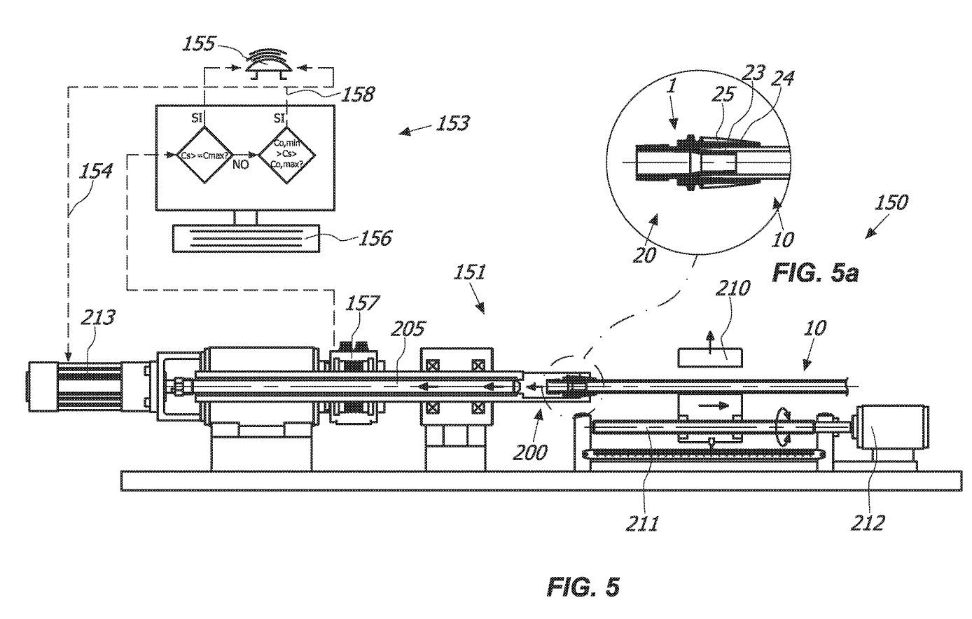

As shown in FIGS. 1a and 1b, the connector 20 can be of the female or male type.

Suitably, the connector 20 may have a first end 21 for coupling to a source of liquid, for example a faucet or the end of a hose, and a second end 22 with a central projection 23 and a peripheral ring 24 mutually faced to define a seat 25 adapted to coaxially receive an end 14 of the flexible hose 10.

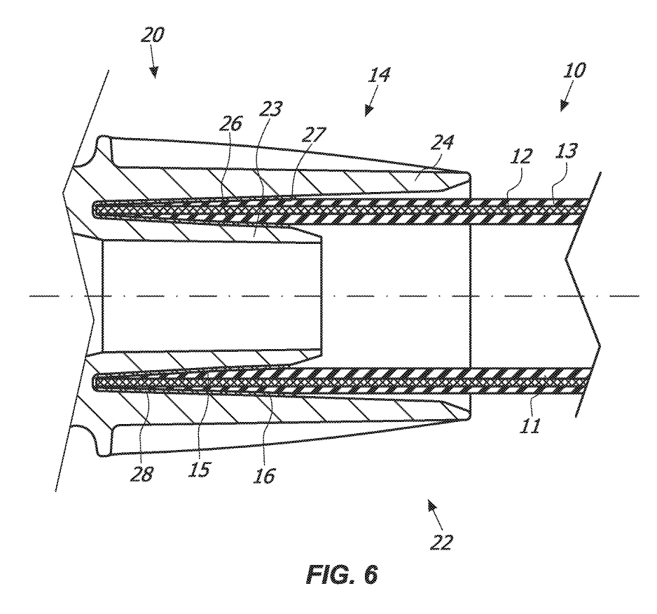

More particularly, as shown in FIG. 6, upon the rotational friction welding the inner surface 15 of the end 14 of the flexible hose 10 remains coupled with the outer surface 26 of the central projection 23, while the outer surface 16 of the end 14 of the flexible hose 10 remains coupled with the inner surface 27 of the peripheral ring 24.

Suitably, the weld develops along the entire weld interface 28, without points of discontinuity along it. This helps to prevent fluid leakage during use of the assembly 1 between the flexible hose 10 and the connector 20.

In a per se known manner, the coupling between the parts will take place due to the melting of the surface layers of the above parts, the melting taking place due to the increase in temperature caused by the rotational friction between the connector 20 and the flexible hose 10.

To ensure optimum welding between the flexible hose 10 and the connector 20, the peripheral ring 24 may have a greater length than that of the central projection 23.

More particularly, the ratio between the length LB of the peripheral ring 24 and the length LA of the central projection 23 may be of 1.2 to 4, more preferably of 1.5 to 2.5.

Moreover, to ensure optimum welding between the flexible hose 10 and the connector 20, the ratio between the length LA of the central projection 23 and the inner diameter Di of the flexible hose 10 may be of 1.2 to 4, more preferably of 1.5 to 2.5.

The above method may be implemented by means of a line 100 which may include a station 110 for manufacturing the flexible hose 10 and a machine 150 for the rotational friction welding of the flexible hose 10 and the connector 20.

However, it is understood that the flexible hose 10 can be produced in a separate location from the one where lies the line 100, or also simply purchased and stored, without departing from the scope of the appended claims.

In this case, the line 100 may not include the station 110 for manufacturing the flexible hose 10, and the flexible hose 10 may be fed to the machine 150 after simple withdrawal from a storage site.

In the case of in-line production of the flexible hose 10, the station 110 for manufacturing the same may include at least one extrusion head 115 of the polymeric material of the layer 11, for example plasticised PVC.

In the case of the garden hose described above, the layer 11 defines the inner layer of the flexible hose 10, and may be fed to a knitting or braiding station 120 that makes the intermediate reinforcing layer 12 on the inner layer 11.

The semifinished product at the output of the knitting or braiding station 120 can then be fed to a second extrusion head 125, which extrudes another polymeric material, which can be still plasticized PVC, so as to form the outer layer 13.

The flexible hose 10 thus formed may be fed to the machine 150, which welds the end 14 thereof to the connector 20.

The latter may be produced in the same place where lies the line 100 or in a different place, or simply purchased and stored, without departing from the scope of the appended claims.

In any case, besides the flexible hose 10, the machine 150 is fed by the connectors 20, one for each hose.

In fact, the machine 150 may include a first section 151 which can house the connector 20 and a second section 152 which can house the end 14 of the flexible hose 10.

In use, the first and second sections 151, 152 may be moved towards each other so that the end 14 of the flexible hose 10 is inserted into the seat 25 of the connector 20, in order to prepare the parts to the subsequent rotational friction welding.

To do this, in a preferred but not exclusive embodiment, the first section 151 may include a seat 200 adapted to receive the connector 20 and a pusher 205 adapted to urge the same connector 20 towards the front opening 201 of the same seat 200.

The relative dimensions of the front opening 201 of the seat 200 and the connector 20 determines how much the latter projects therefrom. In any case, the pusher 205 fixes the connector 20 into the seat 200, so that the former remains stationary upon rotation of the latter.

The end 14 of the flexible hose 10 may be fixed into the clamp 210, which may be slidably moved along a direction substantially parallel to the ground by means of rotation of the shaft 211, driven by the motor 212.

Further, the first section 151 of the machine 150 may suitably be susceptible to cause rotation of the seat 200 by the motor 213, so as to achieve mutually rotationally friction weld the flexible hose 10 and the connector 20 inserted into the seat 200.

Indicatively, the rotation speed of the connector 20 relative to the flexible hose 10 may be of 500 rev/min to 2000 rev/min.

Also, the machine 150 may maintain the flexible hose 10 and the connector 20 mutually urged during the rotation, so that a compressive force develops between them. For example, the motor 212 may act on the clamp 210 to keep urged the flexible hose 10 against the coupling 20 upon the rotation of the seat 200.

Indicatively, the compressive force between the flexible hose 10 and connector 20 may be of 10 N and 250 N.

The time of rotation of the connector 20 with respect to the flexible hose 10 can indicatively be of 3 seconds to 10 seconds.

As explained above, due to the dimensional and structural difference between the parties during the step of rotational friction welding there is the danger that the connector 20 put in rotation the end 14 of the flexible hose 10, thus resulting in collapse of the mechanical junction therebetween.

To overcome this drawback, the machine 150 may further comprise a microprocessor unit 153, for example a PLC, programmed to periodically compare the welding torque Cs that develops between the flexible hose 10 and the connector 20 with the maximum allowable torque Cmax therefor, that is the limit torque at which the connector 20 rotates the flexible hose 10 upon the rotation of the former relative to the latter.

If the microprocessor unit 153 detects a value of the welding torque Cs greater or equal than the maximum allowable torque Cmax, it triggers an alarm signal 154 that stops the rotation of the connector 20 relative to the flexible hose 10. If necessary, the alarm signal 154 can also trigger an acoustic alarm 155.

The value of the maximum allowable torque Cmax may be set into the microprocessor 153, for example by means of a keyboard 156, or preset therein.

In a preferred but not exclusive embodiment, the value of the maximum allowable torque Cmax may be predetermined by the torque meter 157, which may or may not be operatively connected to the microprocessor unit 153.

In case of operative connection between the torque meter 157 and the microprocessor unit 153, the output value from the torque meter can be set directly into the latter.

On the other hand, in case that there is not operative connection between the torque meter 157 and the microprocessor unit 153, the output value from the torque meter can be manually set in the unit microprocessor 153 using the keypad 156.

The calibration operation of the machine 150 with the value of the maximum allowable torque Cmax may be made at the beginning of the production cycle, or whenever there is a change of the operating conditions, for example a change of materials.

In this way, it avoids the danger of structural collapse of the junction, with apparent benefits in terms of times and costs of production.

Moreover, to obtain optimum welding it is necessary that the welding torque Cs is neither too high, in which case the welding between the parts will not be uniform, nor too low, in which case the welding between the parts will not occur due to the fact that the temperature will not reach the melting temperature thereof.

Therefore, the microprocessor unit 153 may advantageously be programmed to periodically compare the welding torque Cs with a range of optimum welding torques Co,min; Co,max between the flexible hose 10 and the connector 20, that is the torques at which the weld interface 28 between the latter extends without interruption over the entire weld interface between the central projection 23 and the peripheral ring 24 of the connector 20.

In other words, the optimum welding torques Co,min; Co,max are those welding torques Cs to which the inner surface 15 of the end 14 of the flexible hose 10 remains coupled with the outer surface 26 of the central projection 23 and the outer surface 16 of the end 14 of the flexible hose 10 remains coupled with the inner surface 27 of the peripheral ring 24, this coupling developing along all the above parts without interruption.

Given the extreme variability of the process parameters, to determine the range of the optimum welding torques Co,min; Co,max at the beginning of the working cycle (or in any case whenever it be deemed necessary) a series of welds between the flexible hose and the connector are to be performed at different welding torques Cs and subsequent verifications of the junctions so formed, for example by visual inspection of a section of the junction.

In this way it is possible to determine a minimum optimal torque value Co,min and a maximum optimal torque value Co,max, respectively below and above which the welding is not satisfactory, as already explained above.

Therefore, using the keyboard 156 such values are set into the microprocessor 153. The value of the welding torque Cs must be between the minimum optimum torque value Co,min and the maximum optimum torque value Co,max.

If the welding torque Cs detected by the microprocessor unit 153 is outside that range, i.e. less than the minimum optimal torque value Co,min or greater than the maximum optimal torque value Co,max, the step of rotation of the connector 20 with respect to the flexible hose 10 is stopped.

To do this, the microprocessor unit 153 triggers an alarm signal 158 that stops the rotation of the connector 20 relative to the flexible hose 10. If necessary, the alarm signal 158 can also trigger an acoustic alarm 155, which can be equal or different from that shown above.

In this way, the product at the output is always welded in an optimal manner, so as to maximize the productivity of the line 100.

To minimize the dimensional changes of the flexible hose 10 at the output from the station 110 of manufacturing the same, a control of the size thereof may be provided.

For this purpose, a laser reader 160 may be provided. Such laser reader 160 may be operatively connected to the microprocessor unit 153. The latter can be set to periodically compare the measured diameter Dr with a nominal diameter Dn preset or settable by means of the keyboard 156.

The microprocessor unit 153 may be operatively connected to a line 170 to deliver air under pressure inside the flexible hose 10.

When the value detected by the laser reader 160 deviates from the nominal diameter, the microprocessor unit 153 triggers a signal 159 which acts on the line 170 so as to inflate/deflate the hose if the measured diameter is less than/greater than the nominal diameter.

Another control system aimed at minimizing the dimensional variations of the flexible hose 10 at the output from the station 110 of manufacturing thereof may be performed on the flow of material passing through the extrusion head 115.

Since the latter is the first of a plurality of devices arranged in series, its speed influences that of the whole process.

For the purpose, a gravimetric scale 180 may be provided which is connected to the load device of the extrusion head 115, which load device can be set to load the material with a specific mass flow.

This gravimetric scale 180 can be operatively connected to the microprocessor 153. The latter can be set to periodically compare the measured weight Wr with an optimal weight Wn preset or adjustable via the keyboard 156.

It is clear that in case the weight Wr detected by the gravimetric scale 180 was different from the optimal one Wn, there is a variation of the mass flow of the extrusion head, with subsequent possible variations of the size of the layer 11 at the output from the extrusion head 115 and, more generally, of the flexible hose 10.

The microprocessor unit 153 may be operatively connected to the endless screw 190 of the extrusion head 115.

When the value measured by gravimetric scale 180 deviates from the preset or presettable weight, the microprocessor unit 153 triggers a signal 159′ which acts on the endless screw 190 so as to increase/decrease the extrusion speed if the detected weight is lower/higher than the optimal weight.

This minimizes the variation of size of the flexible hose 10 at the output from the station 110 of manufacturing thereof.

Conveniently, for each unit of polymer material at the inlet, the control over the mass flow rate of material passing through the extrusion head 115 may occur before the control on the diameter of the hose at the outlet.

The invention will be better understood in the light of the following example.

### EXAMPLE

A flexible hose 10 and a connector 20 has been connected to each other by means of the machine 150.

The flexible hose 10 has an inner layer 11, an intermediate braided layer 12 and an outer layer 13. The inner diameter Di of the flexible hose 10 is of ½″ (12.7 mm).

Both inner and outer layers 11, 13 were made of plasticized PVC (PVC-P) which has the following composition.

| | % by weight |
|---|---|
| Suspension PVC | 53.596 |
| DOP plasticizer | 29.210 |
| Calcium carbonate | 15.543 |
| Ca—Zn stabilizer | 0.463 |
| Epoxidized soybean oil | 1.072 |
| Pigment additive | 0.117 |

The thickness of the inner and outer layers 11, 13 is respectively 1.4 mm and 0.80 mm.

The braided layer is made with threads of 1100 dtex polyester.

The connector 20 is made of rigid PVC (PVC-U). In particular, the peripheral ring 24 and the central projection 23 are made of rigid PVC.

The ratio between the length LB of the peripheral ring 24 and the length LA of the central projection 23 is 2, while the ratio between the length LA of the central projection 23 and the inner diameter Di of the flexible hose 10 is 2.

The rigid PVC by which the connector 20 is made has the following composition.

| | % by weight |
|---|---|
| Suspension PVC | 60.811 |
| Calcium carbonate | 35.661 |
| Ca—Zn stabilizer | 3.529 |

In the following table the mechanical properties of the above mentioned rigid PVC and the plasticized PVC are summarized. In the same table are reported, for comparison purpose, the mechanical properties of a polyamide (Nylon 6,6) and of a polyamide filled with 30% glass fiber having a length of 2 mm.

| | | | PA | PA 6,6 | | |
|---|---|---|---|---|---|---|
| | Measure | PVC-R | 6,6 | GF30% | PVC-P | |
| Main features | Unit | Valori | | | | Standard |
| Density a 23° C. | Kg/dm3 | 1.47 | 1.13 | 1.42 | 1.2 | ISO 1183 |
| Hardness | Shore | 80 D | 80 D | 90 D | 80 A | ISO 868 |
| HDT 1.82 MPa | ° C. | 67 | 80 | 245 | N.A. | ISO 75-2 |
| Elastic modulus | MPa | 3100 | 2900 | 10800 | 1100 | ISO 527 |
| Tensile yield strength | MPa | 45 | 80 | 190 | 21 | ISO 527 |
| Tension at break | Mpa | 40 | 75 | 130 | 17 | ISO 527 |
| Elongation at break | % | 150 | 200 | 3 | 350 | ISO 527 |
| Izod resilience at 23° C. | KJ/m2 | 11 | 30 | 61 | N.A. | ISO 180/4A |
| Melting temperature | ° C. | 180 | 260 | 260 | 150 | // |

The flexible hose 10 and the connector 20 have been fed to the machine 150, which has been set so that the connector 20 rotates with respect to the flexible hose 10 with a rotation speed of about 1000 rev/min. During the rotation, the flexible hose 10 and the connector 20 have been maintained urged one against another with a constant force of 50 N. The time of rotation of the connector 20 with respect to the flexible hose 10 was 5 seconds.

The weld that is created between the flexible hose 10 and connector 20 was optimal, and has developed along the entire weld interface 28 between the peripheral ring 24 and the outer layer 13 and between the central projection 23 and the inner layer 11.

The invention claimed is:

1. A method of manufacturing a hose/connector assembly of polymeric material, the assembly comprising:
a flexible hose (10) comprising at least one layer (11) made of a first thermoplastic material having Shore hardness according to ISO 868 of 50 ShA to 90 ShA; and
a connector (20) made of a second thermoplastic material having Shore hardness according to ISO 868 greater than that of the first thermoplastic material, the first and the second thermoplastic materials being compatible with each other, the connector (20) having a first end (21) configured to be coupled with a liquid source and a second end (22) with a seat (25) configured to coaxially receive an end (14) of the hose (10);
the method comprising the steps of:
providing the flexible hose (10);
providing the connector (20);
mutually approaching the flexible hose (10) and the connector (20) so that the end (14) of the flexible hose (10) is inserted into the seat (25) of the connector (20);
rotating the connector (20) with respect to the flexible hose (10) to provide a rotational friction welding between the flexible hose and the connector, the rotational friction welding extending along an entire weld interface (28) between said end (14) of said flexible hose (10) and said seat (25) of said second end (22) of said connector (20), a welding torque (Cs) occurring between the flexible hose (10) and the connector (20); and
periodically comparing of the welding torque (Cs) with a maximum allowable torque (Cmax) for the flexible hose (10) and the connector (20), the maximum allowable torque (Cmax) being a limit torque at which the connector (20) rotates the flexible hose (10) upon the rotation of the connector with respect to the flexible hose,
wherein the step of rotating the connector (20) with respect to the flexible hose (10) is interrupted if the welding torque (Cs) is equal to or greater than the maximum allowable torque (Cmax).

2. The method according to claim 1, wherein a value of the maximum allowable torque (Cmax) between the connector (20) and the flexible hose (10) is predetermined by a torque meter (157).

3. The method according to claim 1,
wherein said second end (22) of said connector (20) includes a central projection (23) and a peripheral ring (24) mutually facing one another to define said seat (25),
the method further comprising a step of periodically comparing the welding torque (Cs) with a range of optimum welding torques (Co,min; Co,max) for the flexible hose (10) and the connector (20), the optimum welding torques (Co,min; Co,max) being torques at which said weld interface (28) between the flexible hose (10) and connector (20) continuously occurs throughout the central projection (23) and the peripheral ring (24) of the connector (20), said step of rotating the connector (20) with respect to the flexible hose (10) being interrupted if the welding torque (Cs) is outside the range of the optimum welding torques (Co,min; Co,max).

4. The method according to claim 3, wherein said peripheral ring (24) has a length greater than a length of said central projection (23).

5. The method according to claim 4, wherein a ratio between the length (LB) of said peripheral ring (24) and the length (LA) of said central projection (23) is 1.2 to 4.

6. The method according to claim 4, wherein a ratio between the length (LA) of said central projection (23) and an inner diameter (Di) of the hose (10) is 1.2 to 4.

7. The method according to claim 1, wherein said first thermoplastic material has an elastic modulus according to ISO 527 of 700 MPa to 1500 MPa, tensile yield strength according to ISO 527 of 15 MPa to 25 MPa, tension at break according to ISO 527 of 15 MPa to 25 MPa, and elongation at break according to ISO 527 of 300% to 450%.

8. The method according to claim 1, wherein said second thermoplastic material has Shore D hardness according to ISO 868 of 70 Sh D to 100 Sh D.

9. The method according to claim 1, wherein said second thermoplastic material has HDT at 1.82 MPa according to ISO 75-2 of 60° C. and 90° C.

10. The method according to claim 1, wherein said second thermoplastic material has elastic modulus according to ISO 527 of 2500 MPa to 4000 MPa, tensile yield strength according to ISO 527 of 30 MPa to 100 MPa, tension at break according to ISO 527 of 30 MPa to 100 MPa elongation at break according to ISO 527 of 100% to 250%.

11. The method according to claim 1, wherein said second thermoplastic material has Izod resilience at 23° C. according to ISO 180/4A of 10 KJ/m² to 50 KJ/m².

12. The method according to claim 1, wherein said flexible hose (10) includes said at least one layer (11) comprises at least one inner layer coming into contact with a liquid to be transported and at least one protective layer (13) to be grasped by a user, said at least one protective layer (13) being arranged externally with respect to said at least one inner layer (11) coming into contact with the liquid to be transported.

13. The method according to claim 12, wherein said flexible hose (10) has an inner diameter (Di) of ½″, said at least one inner layer having a thickness of 1.3 mm to 1.45 mm, said at least one protective layer (13) having a thickness of 0.75 mm to 0.85 mm.

14. The method according to claim 12, wherein said flexible hose (10) has an inner diameter (Di) of ⅝″, said at least one inner layer having a thickness of 1.4 mm to 1.8 mm, said at least one protective layer (13) having a thickness of 0.80 mm to 1 mm.

15. The method according to claim 12, wherein said flexible hose (10) has an inner diameter (Di) of ¾″, said at least one inner layer having a thickness of 1.6 mm to 1.9 mm, said at least one protective layer (13) having a thickness of 1 mm to 1.1 mm.

16. The method according to claim 3, wherein the range of optimum welding torques (Co,min; Co,max) is predetermined by a series of welds between the flexible hose (10) and the connector (20) at different welding torques (Cs) and a subsequent check of joints made by the welds.

17. The method according to claim 1, wherein the step of providing the flexible hose (10) comprises a step of manufacturing the flexible hose, the step of providing the flexible hose (10) further comprising a step of detecting a diameter (Dr) of the hose (10) before the approaching step with the connector (20) and a step of periodic comparing the detected diameter (Dr) with a predetermined nominal diameter (Dn), the step of providing the flexible hose (10) further comprising a step of inflating/deflating the hose (10) if the detected diameter (Dr) is less than/greater than the predetermined nominal diameter (Dn).

18. The method according to claim 17, wherein said step of detecting the diameter (Dr) of the flexible hose is effected by laser reading of the diameter (Dr).

19. The method according to claim 17, wherein the step of manufacturing the hose (10) includes a step of extruding said first thermoplastic material, said step of providing the flexible hose (10) further comprising a step of periodic detecting a mass flow rate (Wr) of said first thermoplastic material and comparing the detected mass flow rate (Wr) with an optimal mass flow rate (Wn), extrusion speed increasing/decreasing if the detected mass flow rate (Wr) is lower/higher than the optimal mass flow rate (Wn).

20. A line for manufacturing a hose/connector assembly of polymeric material, the assembly comprising:
a flexible hose (10) comprising at least one layer (11) made of a first thermoplastic material having Shore hardness according to ISO 868 of 50 ShA to 90 ShA; and
a connector (20) made of a second thermoplastic material having Shore hardness according to ISO 868 greater than the Shore hardness of the first thermoplastic material, the first and the second thermoplastic materials being compatible with each other, the connector (20) having a first end (21) to be coupled with a liquid source and a second end (22) with a seat (25) configured to coaxially receive an end (14) of the hose (10),
the line comprising:
a station (110) for manufacturing the flexible hose (10); and
a machine (150) for rotational friction welding of the flexible hose (10) and the connector (20), said rotational friction welding extending along an entire weld interface (28) between said end (14) of said hose (10) and said seat (25) of said second end (22) of said connector (20),
wherein the machine (150) includes:
a first section (151) configured to house the connector (20);
a second section (152) configured to house the end (14) of the hose (10), said first and second sections (151, 152) being movable towards each other so that the end (14) of the hose (10) is inserted into the seat (25) of the connector (20), the first section (151) rotating the connector (20) to rotationally friction weld to each other the flexible hose (10) and the connector (20);
at least one torque meter (157) for detecting a welding torque (Cs) between the flexible hose (10) and the connector (20);
a microprocessor unit (153) operatively connected to said at least one torque meter (157) for periodic comparison of the welding torque (Cs) detected by the torque meter with a maximum allowable torque (Cmax) for the hose (10) and the connector (20), the maximum allowable torque (Cmax) being a limit torque at which the connector (20) rotates the flexible hose (10) upon rotation of the connector (20) with respect to the flexible hose (10),
wherein the microprocessor unit (153) is programmed to stop the rotation of the connector (20) with respect to the hose (10) when the welding torque (Cs) is equal to or greater than the maximum allowable torque (Cmax).

21. A machine for rotationally friction weld a flexible hose (10) and a connector (20) to form a hose/connector assembly of polymeric material, the assembly comprising:
a flexible hose (10) comprising at least one layer (11) made of a first thermoplastic material having Shore hardness according to ISO 868 of 50 ShA to 90 ShA; and
a connector (20) made of a second thermoplastic material having Shore hardness according to ISO 868 greater than the Shore hardness of the first thermoplastic material, the first and the second thermoplastic materials being compatible with each other, the connector (20) having a first end (21) to be coupled with a liquid source and a second end (22) with a seat (25) configured to coaxially receive an end (14) of the hose (10), wherein the machine includes:
a first section (151) configured to house the connector (20);
a second section (152) configured to house the end (14) of the hose (10), said first and second sections (151, 152) being movable towards each other so that the end (14) of the hose (10) is inserted into the seat (25) of the connector (20), the first section (151) rotating the connector (20) so as to rotationally friction weld to each other the flexible hose (10) and the connector (20);
at least one torque meter (157) for detecting a welding torque (Cs) between the flexible hose (10) and the connector (20); and
a microprocessor unit (153) operatively connected to said at least one torque meter (157) for periodic comparison of the welding torque (Cs) detected by the torque meter with a maximum allowable torque (Cmax) for the flexible hose (10) and the connector (20), the maximum allowable torque (Cmax) being a limit torque at which the connector (20) rotates the flexible hose (10) upon rotation of the connector (20) with respect to the flexible hose (10),
wherein the microprocessor unit (153) is programmed to stop the rotation of the connector (20) with respect to the hose (10) when the welding torque (Cs) is equal to or greater than the maximum allowable torque (Cmax).
